(19) United States
(12) Patent Application Publication
(10) Pub. No.: US 2009/0021829 A1
(43) Pub. Date: Jan. 22, 2009

(54) OPTICAL MODULE

(75) Inventors: Sung-Nan Chen, Hsinchu (TW); Keng-Han Chuang, Hsinchu (TW); Yi-Hsueh Chen, Hsinchu (TW)

Correspondence Address: J C PATENTS, INC., 4 VENTURE, SUITE 250, IRVINE, CA, 92618, US

(73) Assignee: YOUNG OPTICS INC., Hsinchu (TW)

(21) Appl. No.: 11/968,818

(22) Filed: Jan. 3, 2008

(30) Foreign Application Priority Data
Jul. 20, 2007 (TW) 96126585

(51) Int. Cl. G02B 27/28; G02B 27/10

(52) U.S. Cl. 359/485; 359/495

(57) ABSTRACT

An optical module including a first integration rod, a polarization beam splitting unit, a first reflector, a first quarter-wave plate, and a light source is provided. The first integration rod has a first end and a second end opposite to each other. The polarization beam splitting unit is disposed at a side of the first end. The polarization beam splitting unit reflects a beam with a first polarization direction and allows a beam with a second polarization direction to pass through. The first reflector is disposed at a side of the second end. The first quarter-wave plate is disposed between the polarization beam splitting unit and the first reflector. The light source provides a light beam to the polarization beam splitting unit. The light beam includes a first polarization beam with the first polarization direction. The polarization beam splitting unit reflects the first polarization beam to the first integration rod.

### CROSS-REFERENCE TO RELATED APPLICATION

This application claims the priority benefit of Taiwan application serial no. 96126585, filed on Jul. 20, 2007. The entirety of the above-mentioned patent application is hereby incorporated by reference herein and made a part of this specification.

### BACKGROUND OF THE INVENTION

1. Field of the Invention

The present invention relates to an optical module, and more particularly to an optical module for a projection apparatus.

2. Description of Related Art

Referring to FIG. 1A, a conventional projection apparatus 100 includes a light source 110, an integration rod 120, a transmissive liquid crystal display panel (LCD panel) 130, and a projection lens 140. The light source 110 is used to provide an illumination beam 112, and the integration rod 120 is disposed on the propagation path of the illumination beam 112, so as to uniformize the illumination beam 112. The illumination beam 112 uniformized by the integration rod 120 travels to the transmissive LCD panel 130, and the transmissive LCD panel 130 converts the illumination beam 112 into an image beam 112′. The projection lens 140 is disposed on the propagation path of the image beam 112′, so as to project the image beam 112′ on a screen.

Referring to FIG. 1B, generally speaking, the illumination beam 112 enters the integration rod 120 through a light incident end 122 of the integration rod 120, and then the light rays (e.g. light rays 112a, 112b, and 112c) are reflected within the integration rod 120, so that the illumination beam 112 becomes uniform. However, since the light rays (such as the light rays 112b and 112c) incident at small angles are reflected a fewer times within the integration rod 120, the illumination beam 112 coming out from the light emitting end 124 of the integration rod 120 has a poorer uniformity.

In the prior art, the length of the integration rod 120 is extended to increase the number of times of reflection of the light rays incident at small incident angles within the integration rod 120, thereby improving the uniformity of the illumination beam 112. However, the long integration rod 120 results in that the entire optical system of the projection apparatus 100 becomes too long and the overall volume of the projection apparatus 100 is also increased.

### SUMMARY OF THE INVENTION

The present invention provides an optical module, having the advantage of a small volume and capable of providing a light beam with better uniformity.

The optical module in an embodiment of the present invention includes a first integration rod, a polarization beam splitting unit, a first reflector, a first quarter-wave plate, and a light source. The first integration rod has a first end and a second end opposite to the first end. The polarization beam splitting unit is disposed at a side of the first end. The polarization beam splitting unit is capable of reflecting a light beam with a first polarization direction, and allowing a light beam with a second polarization direction to pass through. The first reflector is disposed at a side of the second end, and the first quarter-wave plate is disposed between the polarization beam splitting unit and the first reflector. The light source provides a light beam to the polarization beam splitting unit, and the light beam includes a first polarization beam with the first polarization direction. The polarization beam splitting unit reflects the first polarization beam to the first integration rod.

In an embodiment of the present invention, an optical module is used to uniformize a light beam. A polarization beam splitting unit reflects a first polarization beam with the first polarization direction to a first integration rod, and allows a second polarization beam with the second polarization direction to pass through. A first quarter-wave plate allows the first polarization beam reflected by the polarization beam splitting unit to pass through and changes a polarization direction of the first polarization beam. The first reflector reflects the first polarization beam passing through the first quarter-wave plate to the first quarter-wave plate, and then makes the first polarization beam to pass through the first quarter-wave plate again, thereby converting the first polarization beam into the second polarization direction for passing through the polarization beam splitting unit.

Since the polarization beam splitting unit and the first reflector are disposed at two ends of the first integration rod, the light beam may pass to and fro once in the first integration rod, thereby improving the uniformity of the light beam. Furthermore, the first quarter-wave plate is used to change the polarization direction of the light beam, thereby making the light beam reflected back to the polarization beam splitting unit pass through the polarization beam splitting unit. In addition, since the uniformity of the light beam is improved without increasing the length of the first integration rod, the optical module has the advantage of small volume.

In order to make the aforementioned and other objects, features and advantages of the present invention comprehensible, preferred embodiments accompanied with figures are described in detail below.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic view of a conventional projection apparatus.

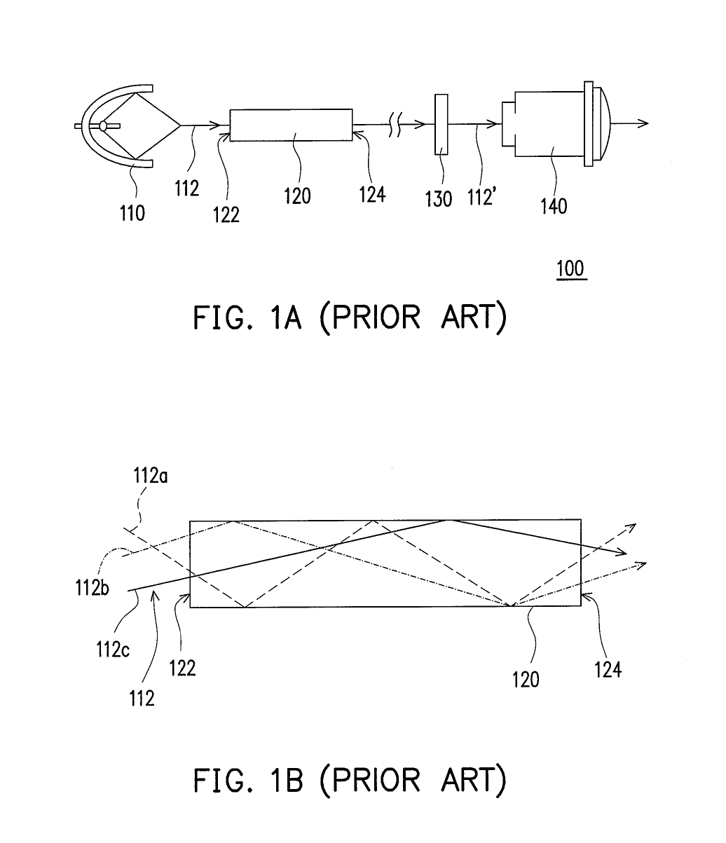

FIG. 1B shows a case of a light beam entering an integration rod shown in FIG. 1A.

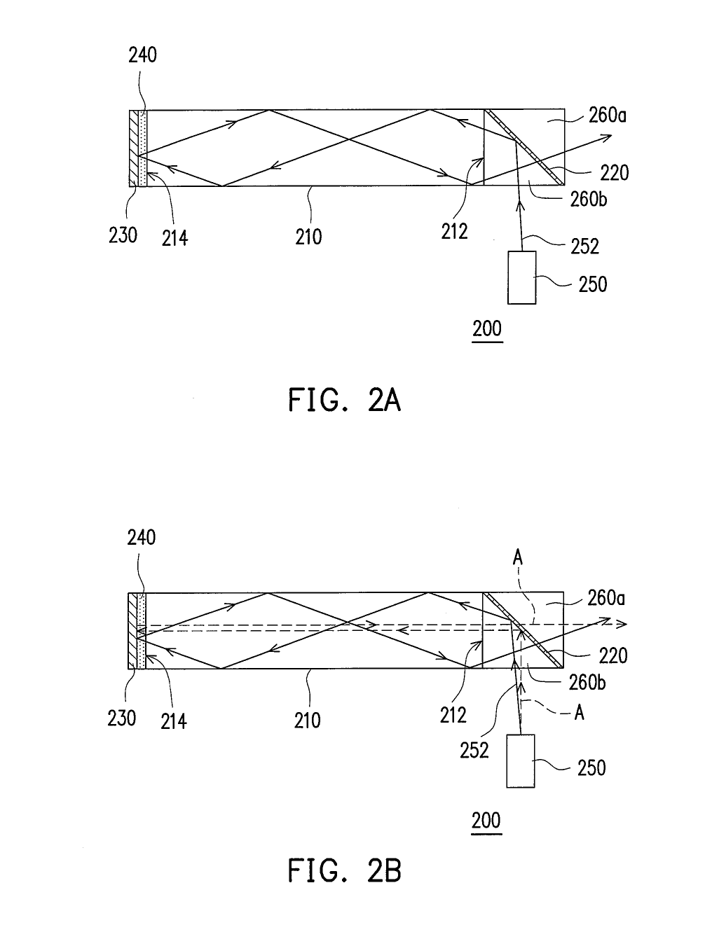

FIG. 2A is a schematic view of an optical module according to an embodiment of the present invention.

FIGS. 2B and 2C are schematic views of optical modules according to other two embodiments of the present invention.

FIGS. 3A-3C are schematic views of optical modules according to other three embodiments of the present invention.

FIG. 4 is a schematic view of an optical module according to yet another embodiment of the present invention.

FIG. 5 is a schematic view of an optical module according to yet another embodiment of the present invention.

FIG. 6 is a schematic view of an optical module according to yet another embodiment of the present invention.

FIGS. 7A and 7B are schematic views of optical modules according to other two embodiments of the present invention.

### DESCRIPTION OF EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

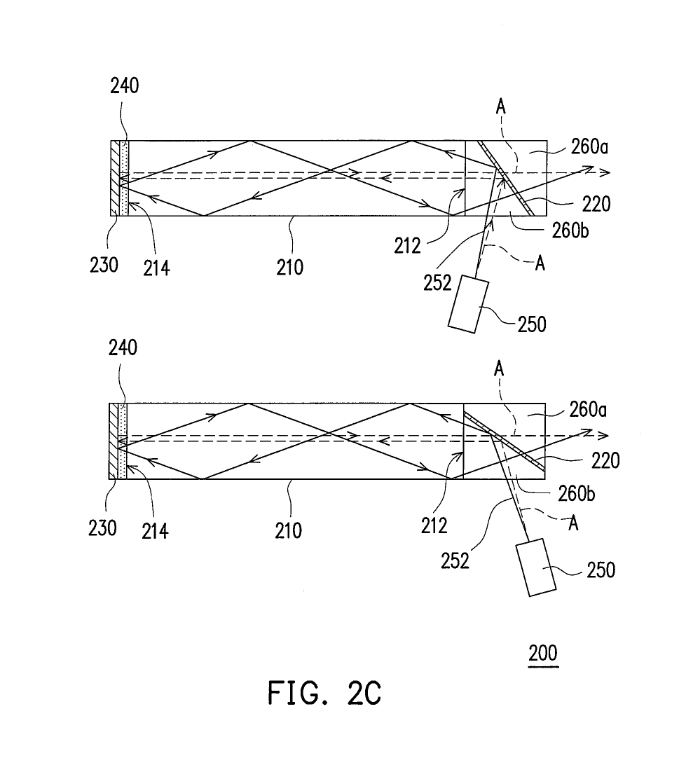

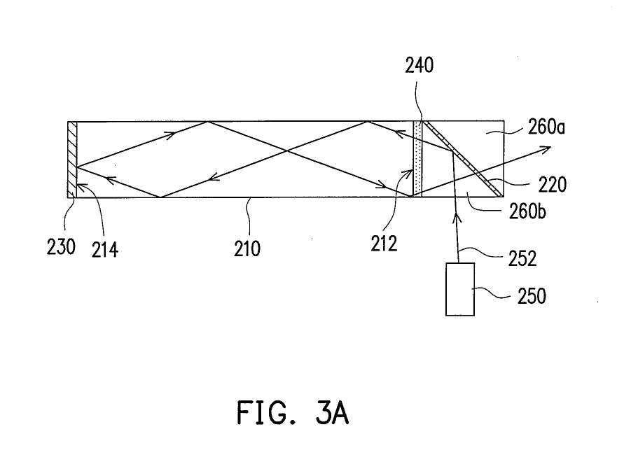

Referring to FIG. 2A, an optical module 200 according to an embodiment of the present invention includes a first integration rod 210, a polarization beam splitting unit 220, a first reflector 230, and a first quarter-wave plate 240. According to another embodiment of the present invention, the optical module 200 may further include a light source 250. The first integration rod 210 has a first end 212 and a second end 214 opposite to the first end 212. The polarization beam splitting unit 220 is disposed at a side of the first end 212, and is inclined at an angle with respect to the first end 212. The polarization beam splitting unit 220 is capable of reflecting a light beam with a first polarization direction, and allows a light beam with a second polarization direction to pass through. In this embodiment, the first polarization direction may be perpendicular to the second polarization direction. For example, the first polarization direction is a P polarization direction, and the second polarization direction is an S polarization direction. Furthermore, the optical module 200 may further include two triangular prisms 260a and 260b disposed at the side of the first end 212. The triangular prisms 260a and 260b form a cube, and the triangular prism 260b is, for example, connected to the first integration rod 210. The polarization beam splitting unit 220 is, for example, a coating layer on a junction surface of the triangular prisms 260a and 260b.

The first reflector 230 is disposed at a side of the second end 214, and, for example, the first quarter-wave plate 240 is disposed between the first reflector 230 and the first integration rod 210. In detail, the first quarter-wave plate 240 is, for example, connected to the first integration rod 210, and the first reflector 230 is, for example, connected to the first quarter-wave plate 240. In addition, the light source 250 is capable of providing a light beam 252 to the polarization beam splitting unit 220. The light source 250 is, for example, a laser light source, and the light beam 252 provided by the laser light source 250 is a first polarization beam with a first polarization direction, and the optical module 200 is used for uniformizing the light beam 252. In this embodiment, the first polarization beam is, for example, a P-polarized beam.

The first integration rod 210 is capable of uniformizing the light beam 252. In detail, the polarization beam splitting unit 220 is capable of reflecting the light beam 252 into the first integration rod 210. After that, the light beam 252 is reflected within the first integration rod 210, and passes through the first quarter-wave plate 240 and reaches the first reflector 230. The first quarter-wave plate 240 changes the polarization direction of the light beam 252. The first reflector 230 reflects the light beam 252 passing through the first quarter-wave plate 240 to the first quarter-wave plate 240, and then the light beam 252 travels to the polarization beam splitting unit 220. Furthermore, after the light beam 252 passes through the first quarter-wave plate 240 twice, the polarization direction of the light beam 252 is rotated by 90 degrees. In other words, after the light beam 252 passes through the first quarter-wave plate 240 twice, the polarization direction of the light beam 252 is converted into the second polarization direction, so the light beam 252 reflected back to the polarization beam splitting unit 220 passes through the polarization beam splitting unit 220.

In this embodiment, since the light beam 252 passes to and fro once in the first integration rod 210, the number of times of reflection of the light beam 252 within the first integration rod 210 is increased. In this manner, the light beam 252 passing through the polarization beam splitting unit 220 has better uniformity. Furthermore, as compared with the prior art, under the precondition that the uniformization effects are the same, the length of the first integration rod 210 in this embodiment is merely half the length of the integration rod in the prior art. Therefore, the optical module 200 in this embodiment has the advantage of small volume. The optical module 200, when applied in the projection apparatus, can reduce the volume of the projection apparatus.

According to another embodiment of the present invention, as shown in FIG. 2B, preferably, after the light beam 252 is reflected by the polarization beam splitting unit 220 to enter the first integration rod 210, an optical axis A of the light beam 252 is parallel to an optical axis of the first integration rod 210. At this time, divergent light is reflected in the first integration rod 210 repeatedly, so as to be converged within a certain angle to achieve the uniformizing effect. In this embodiment, preferably, the polarization beam splitting unit 220 is inclined at an angle of 45 degrees with respect to the first end 212, but the present invention is not limited to this. For example, as shown in FIG. 2C, the optical axis A of the light beam 252, after reflected by the polarization beam splitting unit 220 to enter the first integration rod 210, may be parallel to the optical axis of the first integration rod 210 only by appropriately adjusting the relative positions of the light source 250 and the polarization beam splitting unit 220.

In addition, according to the present invention, the number and the relative positions of all the elements are not limited. Therefore, those of ordinary skill in the art may, for example, set the polarization beam splitting unit 220 to be parallel to the first end 212 (i.e., the inclined angle is 180 or 0 degrees). Then, a plurality of reflecting mirrors may be used to adjust the relative positions of all the elements, so that the optical axis of the light beam 252, after reflected by the polarization beam splitting unit 220 to enter the first integration rod 210, is parallel to the optical axis of the first integration rod 210.

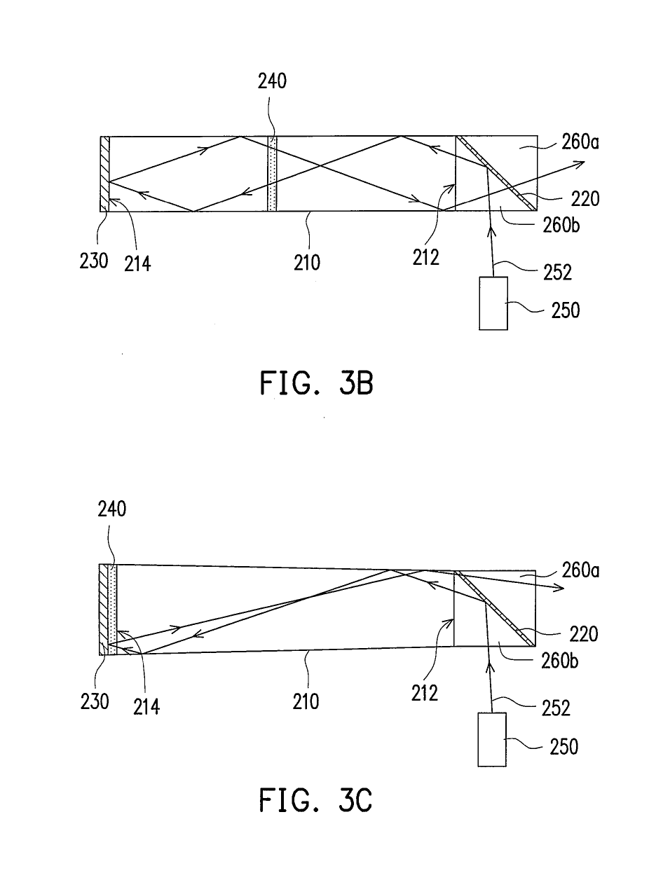

It should be noted that the first integration rod 210 may be a solid or hollow integration rod. Furthermore, the first quarter-wave plate 240 is not limited to be disposed between the first reflector 230 and the first integration rod 210. In fact, the first quarter-wave plate 240 may be disposed between the polarization beam splitting unit 220 and the first reflector 230. For example, the first quarter-wave plate 240 may be disposed between the polarization beam splitting unit 220 and the first integration rod 210 (as shown in FIG. 3A) or disposed within the first integration rod 210 (as shown in FIG. 3B). Furthermore, the first integration rod 210 may be a tapered integration rod (as shown in FIG. 3C).

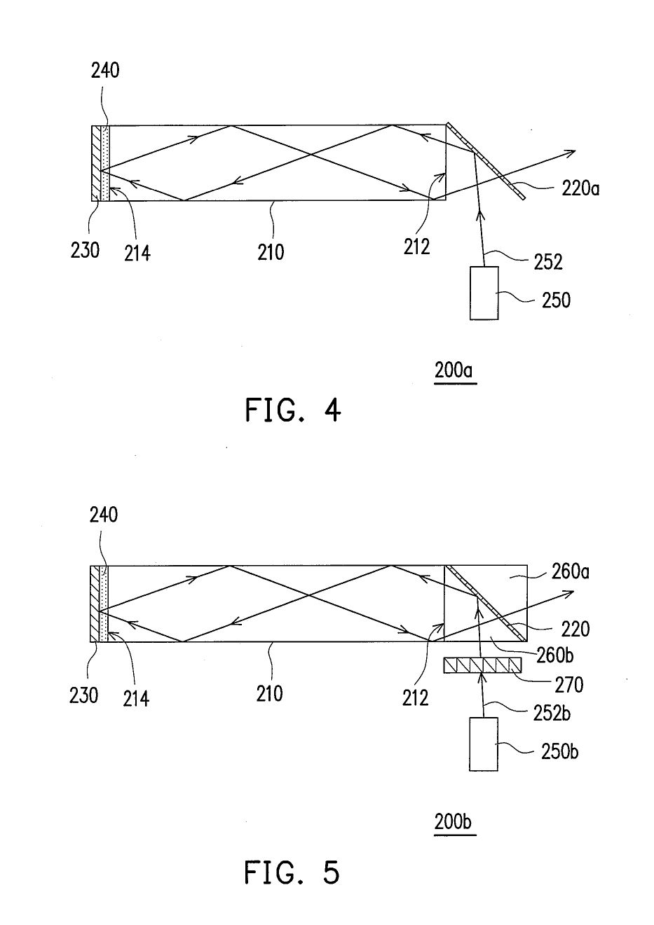

Referring to FIGS. 2A and 4, an optical module 200a according to another embodiment of the present invention and the optical module 200 have similar architecture and advantage, and only the differences between the architectures are illustrated as follows. The polarization beam splitting unit 220 of the optical module 200 is a coating layer disposed on the junction surface of the triangular prism 260a and the triangular prism 260b, while the polarization beam splitting unit 220a of the optical module 200a is a polarization beam splitting plate. Furthermore, the optical module 200a does not need the triangular prisms 260a and 260b.

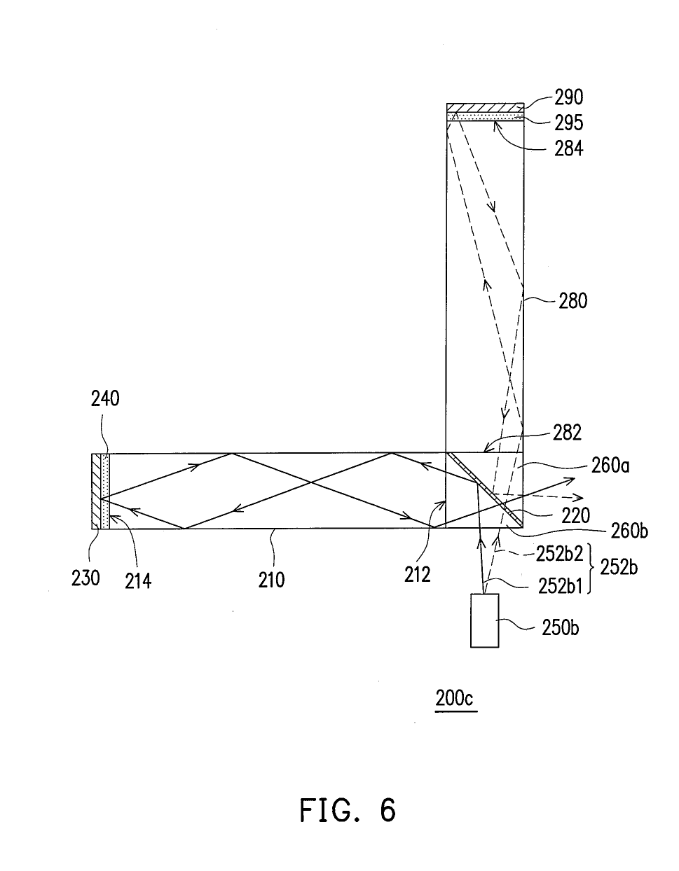

Referring to FIGS. 2A and 5, an optical module 200b according to another embodiment of the present invention and the optical module 200 have similar architecture and advantages, and only the differences between the architectures are illustrated as follows. The light source 250 of the optical module 200 is a laser light source, and the light source 250b of the optical module 200b is not a laser light source. In detail, the light source 250b may be a light emitting diode (LED), a mercury lamp, a halogen lamp, or another incandescent light source. Therefore, the light beam 252b provided by the light source 250b may be a non-polarization beam. In other words, in addition to the first polarization beam with the first polarization direction, the light beam 252b further includes a second polarization beam with a second polarization direction.

Furthermore, a polarization converting unit 270 may be disposed between the light source 250b and the polarization beam splitting unit 220, so as to convert the polarization directions of the light beam 250b into the first polarization direction before being uniformized by the first integration rod 210. In other words, the polarization converting unit 270 is used to convert the second polarization beam into the first polarization beam.

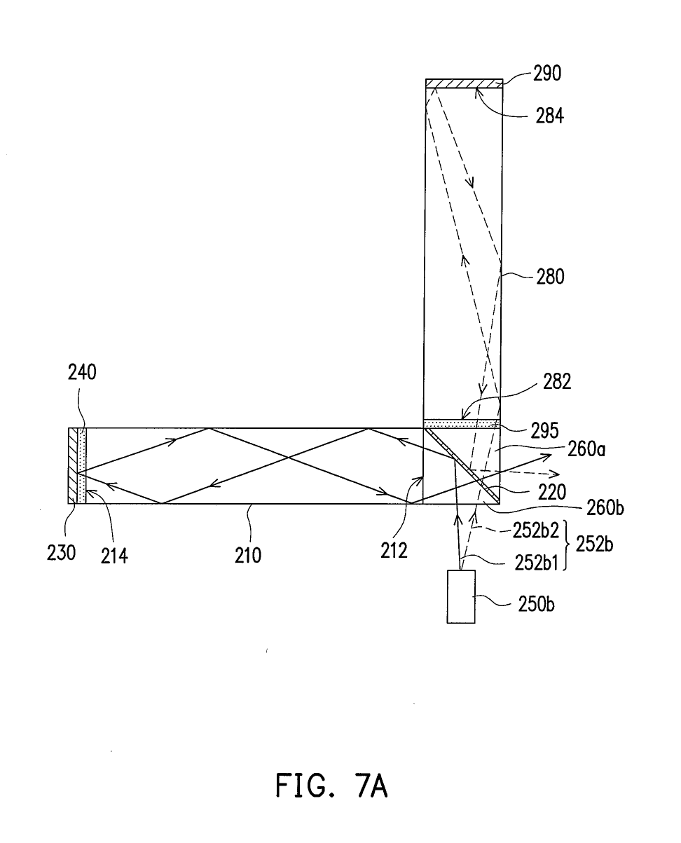

Referring to FIGS. 5 and 6, an optical module 200c according to another embodiment of the present invention and the optical module 200b shown in FIG. 5 have the similar architecture and advantages, and only the differences between the architectures are illustrated as follows. The optical module 200c does not need the polarization converting unit 270 in FIG. 5. Furthermore, as compared with the optical module 200b, the optical module 200c further includes a second integration rod 280, a second reflector 290, and a second quarter-wave plate 295. The second integration rod 280 has a third end 282 and a fourth end 284 opposite to the third end 282. The polarization beam splitting unit 220 is disposed between the second integration rod 280 and the light source 250b, and is adjacent to the third end 282. The second reflector 290 is disposed at a side of the fourth end 284. The second quarter-wave plate 295 is, for example, disposed between the second reflector 290 and the second integration rod 280. In detail, the second quarter-wave plate 295 is, for example, connected to the second integration rod 280, and the second reflector 290 is, for example, connected to the second quarter-wave plate 295.

The light beam 252b1 with the first polarization direction of the light beam 252b has a transmission path similar to that of the light beam 252 of the optical module 200 in FIG. 2A. Therefore, only the transmission path of the light beam 252b2 with the second polarization direction of the light beam 252b is illustrated as follows. The light beam 252b2 passes through the polarization beam splitting unit 220 to enter the second integration rod 280. After that, the light beam 252b2 is reflected within the second integration rod 280, and passes through the second quarter-wave plate 295 to reach the second reflector 290. The second reflector 290 reflects the light beam 252b2 back to the polarization beam splitting unit 220. Furthermore, after the light beam 252b2 passes through the second quarter-wave plate 295 twice, the polarization direction of the light beam 252b2 is rotated by 90 degrees. In other words, after the light beam 252b2 passes through the second quarter-wave plate 295 twice, the polarization direction of the light beam 252b2 becomes the first polarization direction. Therefore, the light beam 252b2 reflected back to the polarization beam splitting unit 220 is reflected by the polarization beam splitting unit 220, and combines with the light beam 252b1 passing through the polarization beam splitting unit 220.

In this embodiment, since the light beam 252b1 passes to and fro once in the first integration rod 210, and the light beam 252b2 passes to and fro once in the second integration rod 280, the numbers of times of reflection of the light beam 252b1 within the first integration rod 210 and the light beam 252b2 within the second integration rod 280 are increased, thereby improving the uniformity of the light beams 252b1 and 252b2. Therefore, the combined light beam of the light beams 252b1 and 252b has better uniformity.

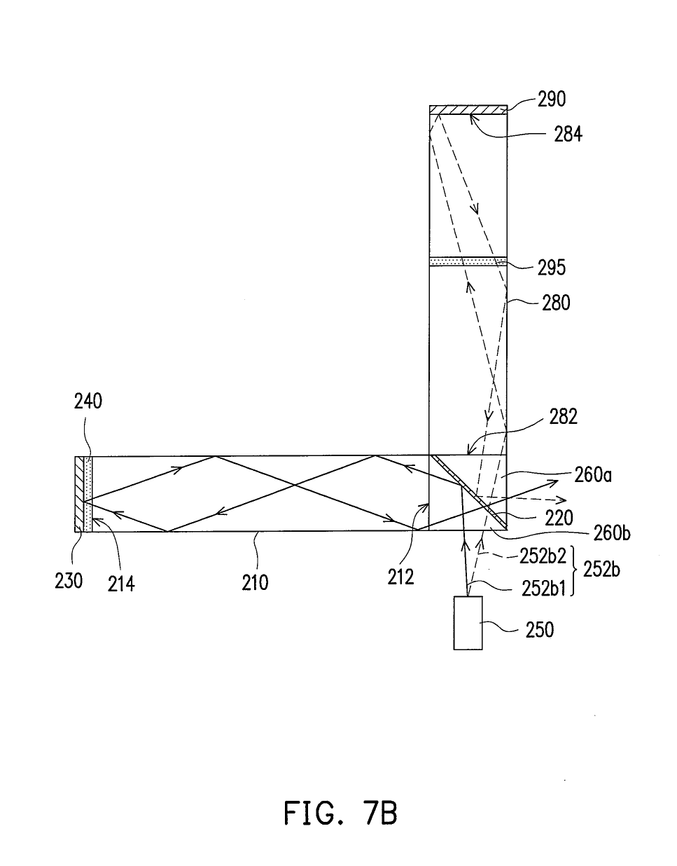

It should be noted that the second integration rod 280 may be a solid or hollow integration rod. Furthermore, the second quarter-wave plate 295 is not limited to be disposed between the second reflector 290 and the second integration rod 280. In fact, the second quarter-wave plate 295 may be disposed between the polarization beam splitting unit 220 and the second reflector 290. For example, the second quarter-wave plate 295 may be disposed between the polarization beam splitting unit 220 and the second integration rod 280 (as shown in FIG. 7A) or disposed within the second integration rod 280 (as shown in FIG. 7B).

In view of the above, since the polarization beam splitting unit and the first reflector are disposed at both sides of the first integration rod, the light beam reflected by the polarization beam splitting unit into the first integration rod is reflected by the first reflector back to the polarization beam splitting unit. In other words, the light beam may pass to and fro once in the first integration rod, so the uniformity of the light beam is better. Furthermore, the polarization direction of the light beam may be changed by the first quarter-wave plate, so that the light beam reflected back to the polarization beam splitting unit may pass through the polarization beam splitting unit. In addition, since the uniformity of the light beam may be improved without increasing the length of the first integration rod, the optical module has the advantage of small volume.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An optical module, comprising:
a first integration rod, having a first end and a second end opposite to the first end;
a polarization beam splitting unit, disposed at a side of the first end, wherein the polarization beam splitting unit is capable of reflecting a first light beam with a first polarization direction and allowing a second light beam with a second polarization direction to pass through;
a first reflector, disposed at a side of the second end;
a first quarter-wave plate, disposed between the polarization beam splitting unit and the first reflector; and
a light source, providing a light beam to the polarization beam splitting unit, wherein the light beam comprises a first polarization beam with the first polarization direction, and the polarization beam splitting unit reflects the first polarization beam to the first integration rod.

2. The optical module as claimed in claim 1, wherein the first quarter-wave plate is disposed between the first reflector and the first integration rod.

3. The optical module as claimed in claim 2, wherein the first quarter-wave plate is connected to the first integration rod, and the first reflector is connected to the first quarter-wave plate.

4. The optical module as claimed in claim 1, wherein the first quarter-wave plate is disposed within the first integration rod.

5. The optical module as claimed in claim 1, wherein the first quarter-wave plate is disposed between the polarization beam splitting unit and the first integration rod.

6. The optical module as claimed in claim 1, wherein the polarization beam splitting unit is a polarization beam splitting plate.

7. The optical module as claimed in claim 1, further comprising two triangular prisms disposed at the side of the first end, wherein the triangular prisms form a cube, and the polarization beam splitting unit is a coating layer on a junction surface of the triangular prisms.

8. The optical module as claimed in claim 1, wherein the light source is a laser light source.

9. The optical module as claimed in claim 1, wherein the light beam provided by the light source further comprises a second polarization beam with the second polarization direction.

10. The optical module as claimed in claim 9, further comprising a polarization converting unit disposed between the light source and the polarization beam splitting unit.

11. The optical module as claimed in claim 9, further comprising:
a second integration rod, having a third end and a fourth end opposite to the third end, wherein the polarization beam splitting unit is disposed between the second integration rod and the light source, and adjacent to the third end;
a second reflector, disposed at a side of the fourth end; and
a second quarter-wave plate, disposed between the polarization beam splitting unit and the second reflector.

12. The optical module as claimed in claim 11, wherein the second quarter-wave plate is disposed between the second reflector and the second integration rod.

13. The optical module as claimed in claim 12, wherein the second quarter-wave plate is connected to the second integration rod, and the second reflector is connected to the second quarter-wave plate.

14. The optical module as claimed in claim 11, wherein the second quarter-wave plate is disposed within the second integration rod.

15. The optical module as claimed in claim 11, wherein the second quarter-wave plate is disposed between the polarization beam splitting unit and the second integration rod.

16. An optical module, for uniformizing a light beam, wherein the light beam comprises a first polarization beam with a first polarization direction and a second polarization beam with a second polarization direction, the optical module comprising:
a first integration rod, capable of uniformizing the light beam;
a polarization beam splitting unit, reflecting the first polarization beam with the first polarization direction to the first integration rod, and allowing the second polarization beam with the second polarization direction to pass through;
a quarter-wave plate, allowing the first polarization beam reflected by the polarization beam splitting unit to pass through, and changing a polarization direction of the first polarization beam;
a reflector, reflecting the first polarization beam passing through the quarter-wave plate to the quarter-wave plate and making the first polarization beam pass through the quarter-wave plate again, thereby converting the first polarization beam into the second polarization direction for passing through the polarization beam splitting unit.

17. The optical module as claimed in claim 16, further comprising two triangular prisms forming a cube, wherein the polarization beam splitting unit is a coating layer on a junction surface of the triangular prisms.

18. The optical module as claimed in claim 16, further comprising a polarization converting unit for converting a polarization direction of the light beam into the first polarization direction before being uniformized by the first integration rod.
